(19) United States
(12) Patent Application Publication
(10) Pub. No.: US 2002/0100198 A1
(43) Pub. Date: Aug. 1, 2002

(54) Metal signs and a method for production thereof

(75) Inventors: Ivor Stone, Raanana (IL); Moshe Tsfaty, Tel Aviv (IL)

Correspondence Address: DR. MARK FRIEDMAN LTD., c/o BILL POLKINGHORN DISCOVERY DISPATCH, 9003 FLORIN WAY, UPPER MARLBORO, MD, 20772, US

(73) Assignee: TADMIT ORIENTATION SYSTEMS LTD.

(21) Appl. No.: 09/770,310

(22) Filed: Jan. 29, 2001

(51) Int. Cl. G09F 1/00

(52) U.S. Cl. 40/616

(57) ABSTRACT

An improved metal sign, a method for production thereof, and a metal plate for use in the method. The sign includes a photographic image of at least one color developed directly on the sign. The method includes the steps of: (a) placing a film of a photographic image over a photosensitive material on a metal plate and causing light to pass through the film so that it exposes at least a portion of the photosensitive material; (b) developing the photosensitive material so that a dye receptive copy of the photographic image is generated on the metal plate; and (c) applying a dye to the metal plate so that a colored copy of the photographic image is created. The metal plate is at least partially coated with a photosensitive material, and includes at least one metal selected from the group consisting of aluminum, copper, iron, steel, gold, silver, beryllium, molybdenum, titanium, tin and lead.

### FIELD AND BACKGROUND OF THE INVENTION

The present invention relates to improved metal signs and a method for production thereof and, more particularly, to producing a photographic image directly on a metal plate. Such images are resistant to extremes of temperature, sunlight and vandalism.

Three companies, Metalphoto of U.S., Gedacolor of Switzerland and Polychromal of the Netherlands describe methods for printing permanent images on Aluminum plates in their web sites (www.metalphoto.com, www.gedacolor.ch and www.polychromal.ni, respectively). Copyphot, Gedacolor and Polycolor are products of Metalphoto, Gedacolor and Polychromal, respectively. Using any of these products, one can print a permanent image on a signboard. Such an image will stay for long time and will not be erased by sunlight and rain. However, all methods and products employed by these companies are specifically limited to use on aluminum plates.

There is thus a widely recognized need for, and it would be highly advantageous to have, improved metal signs and a method for production thereof devoid of the above limitation.

### SUMMARY OF THE INVENTION

According to one aspect of the present invention there is provided an improved metal sign. The sign comprises a photographic image of at least one color developed directly on the sign.

According to another aspect of the present invention there is provided a method for producing an improved metal sign which includes a photographic image of at least one color printed directly on the sign. The method includes the steps of (a) placing a film of a photographic image over a photosensitive material on a metal plate and causing light to pass through the film so that it exposes at least a portion of the photosensitive material; (b) developing the photosensitive material so that a dye receptive copy of the photographic image is generated on the metal plate; and (c) applying a dye to the metal plate so that a colored copy of the photographic image is created.

According to yet another aspect of the present invention there is provided a metal plate at least partially coated with a photosensitive material, wherein the metal plate includes at least one metal selected from the group consisting of aluminum, copper, iron, steel, gold, silver, beryllium, molybdenum, titanium, tin and lead. Placing a film of a photographic image over the photosensitive material on such a metal plate and causing light to pass through the film produces a copy of at least a portion of the photographic image on the metal plate.

According to further features in preferred embodiments of the invention described below, the photographic image is composed of a plurality of colors.

According to still further features in the described preferred embodiments the metal includes at least one metal selected from the group consisting of aluminum, copper, iron, steel, gold, silver, beryllium, molybdenum, titanium, tin, lead and chromium.

According to still further features in the described preferred embodiments the sign further includes a mounting base.

According to still further features in the described preferred embodiments the sign further comprises a mechanism for displaying information which is not part of the photographic image.

According to still further features in the described preferred embodiments the sign further comprises a protective coating.

According to still further features in the described preferred embodiments the method further includes the step coating the metal plate with the photosensitive material.

According to still further features in the described preferred embodiments the method includes the additional step of repeating the steps placing a film, developing, dyeing and coating with a photosensitive material at least one time such that a multicolored image is created on the metal plate.

According to still further features in the described preferred embodiments the method further comprises the step of affixing a mounting base to the metal plate.

According to still further features in the described preferred embodiments the method further comprises the step of providing a mechanism for displaying information on the metal sign which is not part of the photographic image.

According to still further features in the described preferred embodiments the method comprises the additional step of causing the metal plate to be curved.

According to still further features in the described preferred embodiments the metal plate is curved.

The present invention successfully addresses the shortcomings of the presently known configurations by providing improved metal signs and a method for production thereof which is more versatile than previous alternatives.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic representation of an improved metal sign according to the present invention;

FIG. 2 is a block diagram showing steps of a method according to the present invention; and

FIG. 3 is a schematic representation of a metal plate for production of an improved metal sign according to the present invention.

### DESCRIPTION OF THE PREFERRED EMBODIMENTS

The present invention is of improved metal signs, a method for production thereof and metal plates for use in the production thereof. Specifically, the improved signs are distinguished by their durability and resistance to extremes of temperature, sunlight and vandalism.

The principles and operation of improved metal signs, a method for production thereof and metal plates for use in the production thereof according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

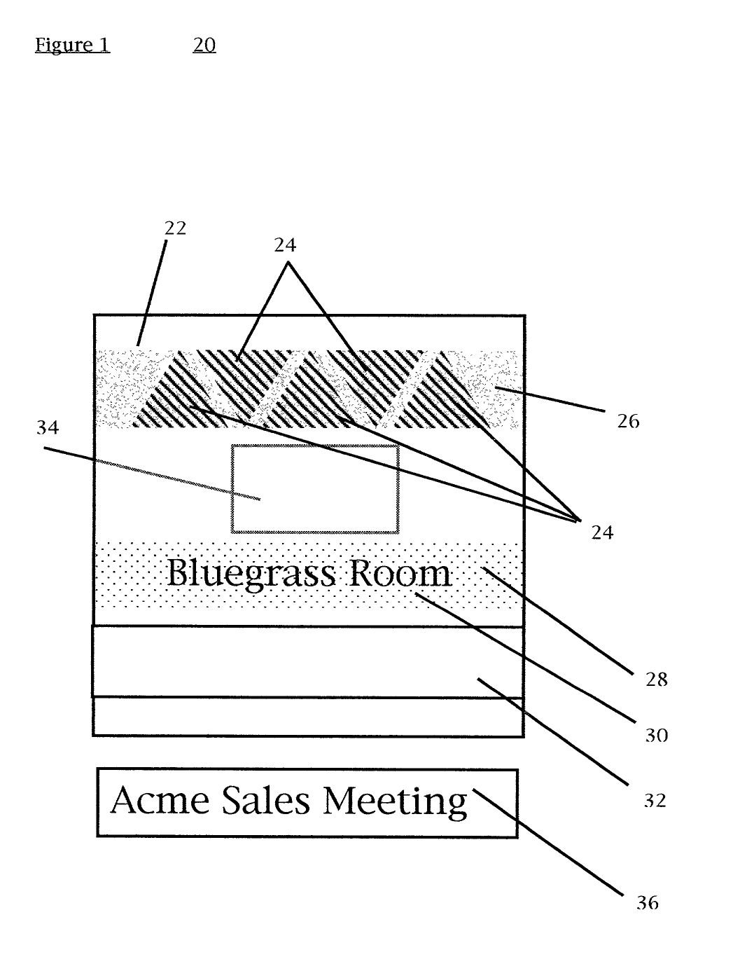

FIG. 1 shows an improved metal sign 20 according to the present invention. Sign 20 includes a photographic image of at least one color (24, is 26, 28, and 30) developed directly on a metal plate 22 from which the sign is formed. According to preferred embodiments of the invention, the photographic image is composed of a plurality of colors (e.g. 24, 26, 28, and 30). Metal plate 22 may include, for example, aluminum, copper, iron, steel, gold, silver, beryllium, molybdenum, titanium, tin, lead, chromium or any combination thereof. Sign 20 may further include a mounting base 34. Sign 20 may further include a mechanism 32 for displaying information 36 which is not part of the photographic image. Mechanism 32 may be, for example, a slot, window, ridge, or groove. Information 36 may be, for example, text. According to preferred embodiments of the present invention sign 20 further includes a protective coating. The protective coating is typically transparent and protects against temperature, UV irradiation, abrasion and malicious mischief.

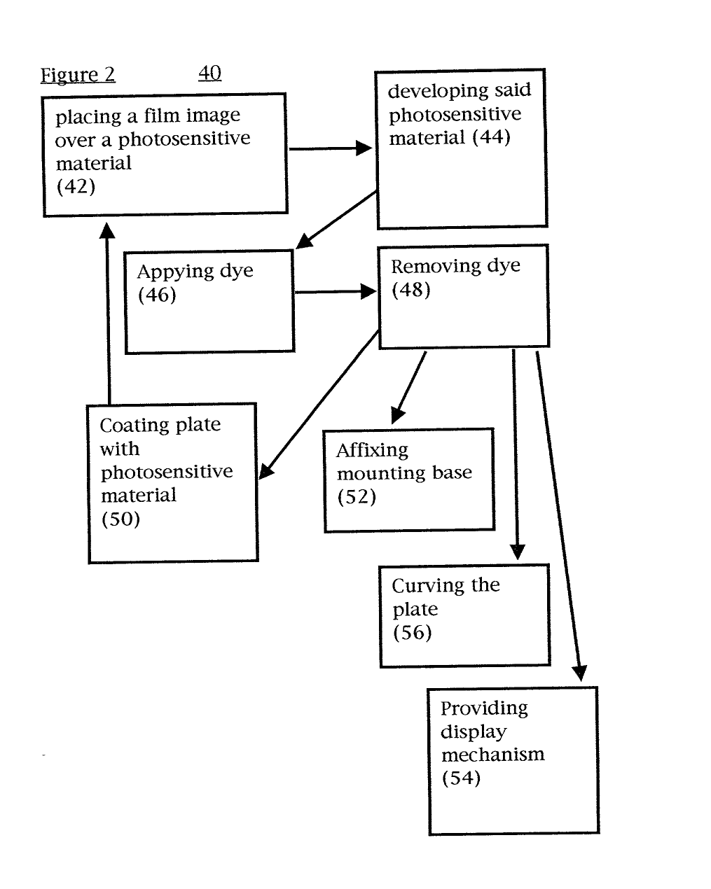

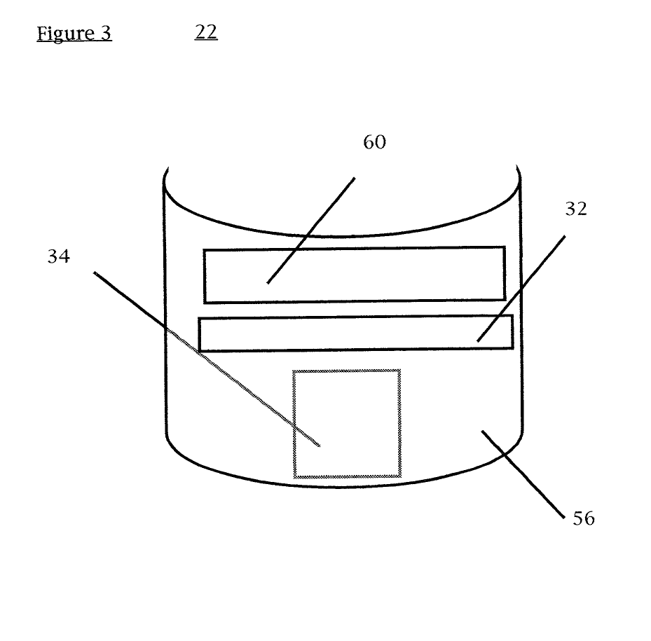

The present invention is further embodied by a method 40 (FIG. 2) for producing an improved metal sign 20 which includes a photographic image of at least one color (e.g. 24) printed directly on sign 20. The method includes at least 3 steps. The first step includes placing a film 42 of a photographic image over a photosensitive material 60 on metal plate 22 (FIG. 3) and causing light to pass through the film so that it exposes at least a portion of photosensitive material 60. The second step includes developing 44 photosensitive material 60 so that a dye receptive copy of the photographic image is generated on metal plate 22. The third step includes applying a dye 46 to metal plate 22 so that a colored copy of the photographic image is created. In some instances, removing dye 48 from a portion of the plate may be necessary. The method may further include the additional step of coating 50 metal plate 22 with photosensitive material 60.

According to preferred embodiments method 40 includes the additional step of repeating the steps placing a film 42, developing 44, dyeing 46 and coating 50 with photosensitive material 60 at least one time such that a multicolored image is created on metal plate 22.

Method 40 may further include the step of affixing a mounting base 34 to metal plate 22. Method 40 may further include the step of providing a mechanism 32 for displaying information 36 on metal sign 20, which is not part of the photographic image.

Method 40 may further include the additional step of causing metal plate 22 to be curved 56. This step may be carried out before, during or after application of the photographic image to metal plate 22.

The present invention is further embodied by metal plate 22 at least partially coated with a photosensitive material 60 wherein metal plate 22 includes, for example, aluminum, copper, iron, steel, gold, silver, beryllium, molybdenum, titanium, tin, lead, chromium or any combination thereof. Placing 42 a film of a photographic image over photosensitive material 60 on metal plate 22 and causing light to pass through the film produces a copy of at least a portion of the photographic image on metal plate 22. Metal plate 22 is curved according to some preferred embodiments of the invention.

As an illustrative example of a metal sign 20 of the present invention, FIG. 1 illustrates a wall plate for posting outside a meeting room in a hotel or convention center. Sign 20 includes a mounting bracket 34, decorative image (24, 26 and 28) applied according to method 40 and changeable text 36 for display in mechanism 32. Text 30 which designates the name of the room is a permanent feature of the sign applied by method 40.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, Internet sites, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An improved metal sign, the sign comprising a photographic image of at least one color developed directly on the sign.

2. The metal sign of claim 1, wherein said photographic image is composed of a plurality of colors.

3. The metal sign of claim 1, wherein the metal includes at least one metal selected from the group consisting of aluminum, copper, iron, steel, gold, silver, beryllium, molybdenum, titanium, tin, lead and chromium.

4. The metal sign of claim 1, further comprising a mounting base.

5. The metal sign of claim 1 further comprising a mechanism for displaying information which is not part of said photographic image.

6. The metal sign of claim 1, further comprising a protective coating.

7. A method for producing an improved metal sign which includes a photographic image of at least one color printed directly on the sign, the method comprising the steps of:
(a) placing a film of a photographic image over a photosensitive material on a metal plate and causing light to pass through said film so that it exposes at least a portion of said photosensitive material;
(b) developing said photosensitive material so that a dye receptive copy of the photographic image is generated on said metal plate; and
(c) applying a dye to said metal plate so that a colored copy of said photographic image is created.

8. The method of claim 7, further comprising the step of:
(d) coating said metal plate with said photosensitive material.

9. The method of claim 8, comprising the additional step of:
(e) repeating steps (a) through (d) at least one time such that a multicolored image is created on said metal plate.

10. The method of claim 7, wherein said metal plate includes at least one metal selected from the group consisting of aluminum, copper, iron, steel, gold, silver, beryllium, molybdenum, titanium, tin, lead and chromium.

11. The method of claim 7, further comprising the step of affixing a mounting base to said metal plate.

12. The method of claim 7, further comprising the step of providing a mechanism for displaying information on the metal sign which is not part of said photographic image.

13. The method of claim 7, comprising the additional step of causing said metal plate to be curved.

14. A metal plate at least partially coated with a photosensitive material, wherein said metal plate includes at least one metal selected from the group consisting of aluminum, copper, iron, steel, gold, silver, beryllium, molybdenum, titanium, tin, lead and chromium;
wherein placing a film of a photographic image over said photosensitive material and causing light to pass through said film produces a copy of at least a portion of said photographic image on the metal plate.

15. The metal plate of claim 14, further comprising a mounting base.

16. The metal plate of claim 14, further comprising a mechanism for displaying information which is not part of said photographic image.

17. The metal plate of claim 14, wherein the metal plate is curved.
